(19) United States
(12) Patent Application Publication
(10) Pub. No.: US 2015/0273358 A1
(43) Pub. Date: Oct. 1, 2015

(54) APPLICATION APPARATUS AND DEFOAMING METHOD

(71) Applicant: SCREEN Holdings Co., Ltd., Kyoto (JP)

(72) Inventor: Koji FURUICHI, Kyoto (JP)

(21) Appl. No.: 14/604,865

(22) Filed: Jan. 26, 2015

(30) Foreign Application Priority Data
Mar. 25, 2014 (JP) 2014-062287

(51) Int. Cl. B01D 19/00; B05B 1/00

(52) U.S. Cl. CPC B01D 19/0042; B05B 1/00

(57) ABSTRACT

An application apparatus includes a storage 100 which stores a non-Newtonian pasty liquid AL, a flow pipe 11, 13, 15 in which the liquid fed from the storage 100 is caused to flow and an application nozzle which is connected to the pipe and applies the liquid on an application object by discharging the liquid. A bubble trap 131 formed of a material having lower wettability with the liquid than a neighboring inner wall material and configured to trap bubbles included in the liquid is provided on a part of an inner wall of the flow pipe.

### CROSS REFERENCE TO RELATED APPLICATION

The disclosure of Japanese Patent Application No. 2014-062287 filed on Mar. 25, 2014 including specification, drawings and claims is incorporated herein by reference in its entirety.

### BACKGROUND OF THE INVENTION

1. Field of the Invention

This invention relates to an application apparatus for applying a non-Newtonian pasty high-viscosity liquid to an application object and a defoaming method for removing bubbles from such a high-viscosity liquid.

2. Description of the Related Art

As a technique to form a wiring pattern on a surface of a substrate such as a glass substrate or a solar cell substrate or form an active material layer on a surface of a current collector, it is known to apply a pasty liquid containing a wiring material or an active material on a substrate or the like. For example, an application apparatus disclosed in JP2013-004400A manufactures an electrode for battery by applying a paste containing an active material and a conductive material on a support by die coating method.

In this technique, if bubbles are mixed into the pasty liquid, they causes a pressure loss when the liquid is fed under pressure, thereby presenting a problem of making a flow rate unstable and causing application defects on a formed pattern. Thus, the bubbles need to be removed from the paste. The above literature does not mention about the problem of bubbles possibly included in the paste.

On the other hand, a method for leaving a liquid to stand under an atmospheric pressure or under a reduced pressure and dissipating bubbles in the liquid by moving the bubbles to a liquid surface, a centrifugal defoaming method for removing bubbles by a centrifugal force and other methods are known as general defoaming techniques for removing bubbles from a liquid. However, it requires a great deal of time to move bubbles in a non-Newtonian high-viscosity pasty liquid. Particularly, a defoaming action by the above techniques can be virtually hardly expected, for example, in a high-viscosity liquid of about 100 Pa·s or higher at a shear rate of 10 s⁻¹. There is also a technique for promoting the defoaming of bubbles by heating, but such a technique cannot be used if a liquid may be changed in quality by heating. Accordingly, it is desired to establish a technique capable of effectively removing bubbles even from such a high-viscosity liquid, but such a technique has not been proposed thus far.

### SUMMARY OF THE INVENTION

This invention was developed in view of the above problem and aims to provide a technique capable of effectively removing bubbles from a non-Newtonian pasty high-viscosity liquid.

An application apparatus according to the present invention comprises: a storage which stores a non-Newtonian pasty liquid; a flow pipe in which the liquid fed from the storage is caused to flow; an application nozzle which is connected to the pipe and discharges the liquid to apply the liquid on an application object, wherein a part of an inner wall of the flow pipe is formed of a material having lower wettability with the liquid than a neighboring inner wall material of the flow pipe and functions as a bubble trap for trapping bubbles included in the liquid.

According to the findings of the inventor of this application, when a non-Newtonian pasty high-viscosity liquid is caused to flow in a pipe, bubbles included in the liquid gradually approach an inner wall of the pipe as the liquid flows and are finally flowed to a downstream side along a pipe wall. Although described in detail later, this is thought to be because the non-Newtonian liquid flowing in the pipe has a property of having a slower flow velocity and, on the other hand, a lower viscosity in a part close to the pipe wall than a part close to a pipe axis and such a flow applies a force in a direction from the pipe axis toward the pipe wall to the bubbles.

Further, the inventor of this application found out that, if a part of the pipe wall was lower in wettability with the liquid than other parts of the pipe wall at this time, more bubbles adhered to this part than the other parts. This is thought to be because the liquid tends to be repelled from a surface of this part due to the difficulty of this part to wet and a more stable state is achieved when bubbles are present between the surface of this part and the liquid than when the surface of this part and the liquid are directly in contact.

The invention utilizes this phenomenon. Specifically, the bubble trap formed of the material having low wettability is provided on a part of the inner wall of the flow pipe in which the liquid is caused to flow. As the liquid flows, the bubbles moving to the pipe wall are guided to the bubble trap having lower wettability than the surrounding to be trapped. Thus, the liquid including less bubbles can be supplied to a side downstream of the bubble trap in the flowing direction of the liquid.

As just described, according to the invention, bubbles can be effectively removed even from a non-Newtonian pasty high-viscosity liquid. Thus, in the application apparatus of the invention, a liquid having bubbles removed therefrom is supplied to the application nozzle and applied on the application object, whereby defect-free application can be performed at a stable application amount.

Further, a defoaming method for removing bubbles from a non-Newtonian pasty liquid according to the present invention comprises the steps of: causing the liquid to flow into a flow pipe; and causing bubbles in the liquid to adhere to a bubble trap provided on a part of an inner wall of the flow pipe and formed of a material having lower wettability with the liquid than a neighboring inner wall material of the flow pipe, thereby removing the bubbles.

In the thus configured invention, the included bubbles are caused to approach the pipe wall by causing the liquid to flow in the flow pipe based on the above principle and caused to adhere to the bubble trap having partially lower wettability with the liquid to be trapped. By doing so, the amount of the bubbles in the liquid fed to a side downstream of the bubble trap in the flowing direction of the liquid can be effectively reduced.

According to the invention, the bubbles in the liquid are moved toward the inner wall of the pipe and trapped by the bubble trap having low wettability with the liquid by causing the liquid to flow in the flow pipe. In this way, the bubbles in the flow pipe can be effectively removed.

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

### BRIEF DESCRIPTION OF THE DRAWINGS

FIGS. 1A through 1D are diagrams showing the principle of a defoaming method according to the invention.

FIG. 2 is a diagram showing a first embodiment of an application apparatus according to this invention.

FIG. 3 is a side sectional view showing the internal structures of the defoaming unit and the reflux pipe.

FIGS. 4A through 4C are diagrams showing a second embodiment of the application apparatus according to this invention.

FIGS. 5A through 5C are diagrams showing a third embodiment of the application apparatus according to this invention.

FIG. 6 is a diagram showing a fourth embodiment of the application apparatus according to this invention.

FIG. 7 is a table showing examples of the material usable as the pipe material.

### DETAILED DESCRIPTION OF THE PREFERRED EMBODIMENTS

Hereinafter, several embodiments of an application apparatus according to the invention are successively described. As described later, the application apparatuses of these embodiments are apparatuses for applying a pasty application liquid to a sheet-like application object conveyed by a roll-to-roll method. For example, these apparatuses can be used for the purpose of manufacturing an electrode for a battery such as a lithium ion secondary battery by using, for example, a sheet-like base material, which functions as a current collector, as an application object and applying an application liquid containing an active material on this application object.

The application liquid is a non-Newtonian pasty liquid containing the active material and a solvent and specifically having a viscosity of, for example, about 100 Pa·s to 300 Pa·s at a shear rate of 10 s⁻¹. By using such a high-viscosity application liquid, dripping after application is reduced and a cross-sectional shape of a formed pattern is easily controlled. Further, since the used amount of the solvent can be reduced, a time required for drying after application can be shorter and an environment burden can be reduced.

In such a non-Newtonian high-viscosity liquid, it is very difficult to remove the bubbles into the liquid. That is, if a liquid has a low viscosity, bubbles can be removed, for example, by being caused to surface to a liquid surface by being left to stand or decompressing an atmosphere. However, since fluidity is low in the high-viscosity liquid, hardly any effect can be expected with such defoaming methods. Each of the application apparatuses of the embodiments described later has a configuration for removing bubbles from such a high-viscosity liquid. First, the principle of a defoaming technique common to these embodiments is described based on the findings of the inventors of this application concerning the behavior of a high-viscosity liquid flowing in a pipe.

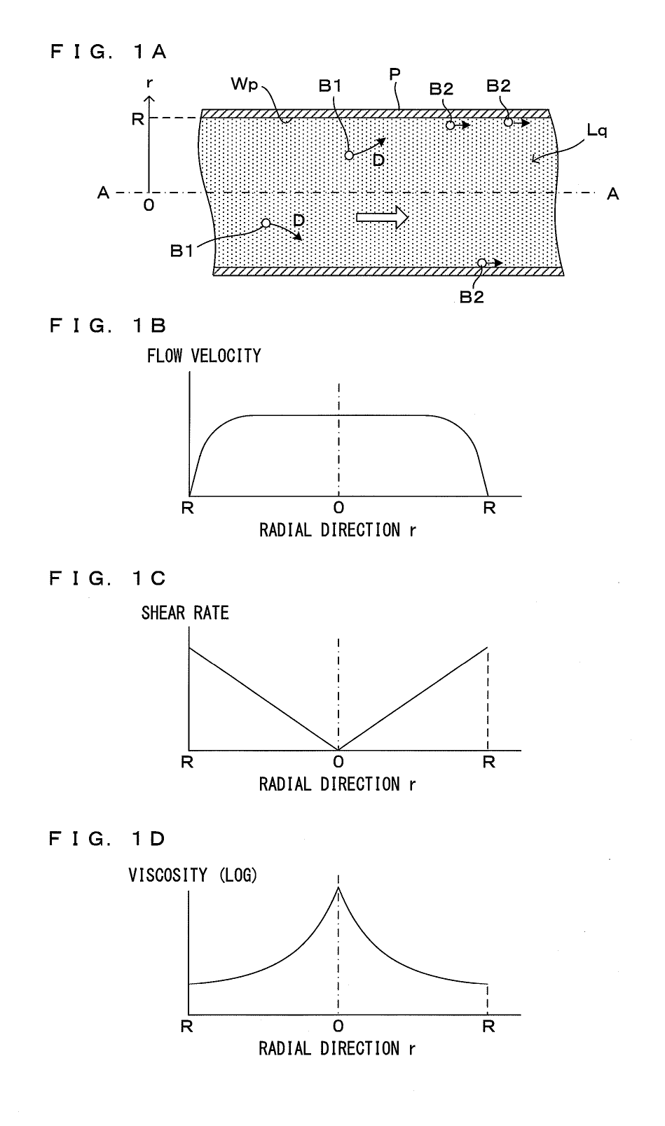

FIGS. 1A through 1D are diagrams showing the principle of a defoaming method according to the invention. As shown in FIG. 1A, a case where a liquid Lq flows in a pipe P having a circular cross-section of a radius R (diameter 2R) is considered as an example. In FIG. 1A, a straight line A-A indicates a pipe axis and a coordinate axis in a radial direction from the pipe axis is denoted by r. An outline arrow indicates a flowing direction of the liquid Lq. As shown by the arrow, the liquid Lq flows from left to right of FIG. 1A in the pipe P in this example. Specifically, a left side of FIG. 1A is an upstream side and a right side is a downstream side in the flowing direction of the liquid Lq.

If the liquid Lq is a non-Newtonian high-viscosity liquid, a flow in the pipe exhibits a characteristic of a plug flow. Specifically, as shown in FIG. 1B, a flow velocity distribution in the radial direction is substantially constant in a central part of a pipe cross-section including the vicinity of the pipe axis, but is very low in parts near a pipe wall. Further, as shown in FIG. 1C, a shear rate of the liquid Lq monotonously increases from the pipe axis to the pipe wall. Further, as shown in FIG. 1D, the viscosity of the liquid Lq is highest near the pipe axis and becomes lower toward the pipe wall. Note that although the pipe P having a circular cross-section is assumed here, a characteristic substantially similar to the above is exhibited in a direction from a pipe axis toward a pipe wall also in a pipe having another cross-sectional shape.

A case where bubbles B1 are included in such a flow is considered. The bubbles B1 receive a force acting in a direction from the pipe axis to a pipe wall Wp from the liquid Lq in the liquid due to the flow velocity distribution that is high near the pipe axis and low near the pipe wall Wp as shown in FIG. 1B. Thus, the bubbles gradually approach the pipe wall Wp while flowing in a downstream direction (rightward in FIG. 1A) indicated by arrows D of FIG. 1A due to a liquid flow. Finally, the bubbles adhere to the pipe wall Wp as denoted by symbols B2. The bubbles B2 slowly move to a downstream side along the pipe wall Wp since the flow velocity is low near the pipe wall Wp.

The inventors of this application found out that whether or not bubbles adhered to the pipe wall Wp differed depending on a material constituting the pipe wall Wp at this time. Specifically, even if the flow velocity of the liquid Lq is the same, bubbles adhere to the pipe wall Wp when the pipe wall Wp is formed of a material having low wettability with the liquid and do not adhere to the pipe wall Wp when the pipe wall Wp is formed of a material having higher wettability. This is thought to be because, if the material has low wettability, a state where the material and the liquid are directly in contact is unstable and a more stable state is achieved when bubbles are present between the material and the liquid. In other words, a pipe wall having poor wettability with the liquid is a stable adherence destination for bubbles. Thus, bubbles adhering to the pipe wall having low wettability with the liquid are difficult to separate and a moving speed thereof is low.

Using such findings, bubbles can be removed from a high-viscosity liquid. Specifically, the bubbles included in the liquid are brought close to a pipe wall by causing the high-viscosity liquid to flow in a pipe. A part of an inner wall of the pipe is formed of a material having lower wettability with the liquid than other parts of the pipe. By doing so, the bubbles moving along the pipe wall adhere to the part having low wettability in a concentrated manner, and this part can be caused to function as a bubble trap for trapping the bubbles.

Each embodiment described below has a configuration for removing bubbles from a high-viscosity liquid flowing in a pipe by trapping the bubbles by a material having low wettability with the liquid as described above. This configuration and effects thereof are described below for each embodiment.

### First Embodiment

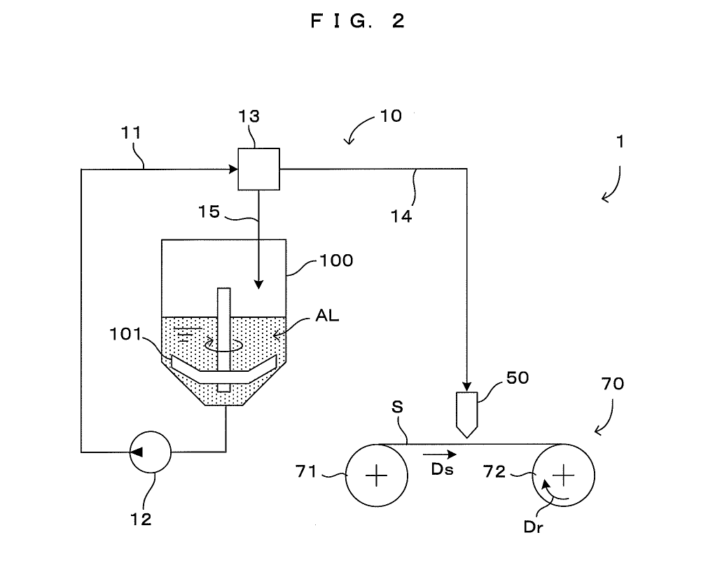

FIG. 2 is a diagram showing a first embodiment of an application apparatus according to this invention. This application apparatus 1 is an apparatus for applying paste-like application liquid to a sheet-like base material S fed by a roll-to-roll method and can be used, for example, in the production of electrodes for batteries such as lithium ion secondary batteries.

This application apparatus 1 includes a tank 100 for storing the application liquid to be applied inside, and a nozzle 50 for discharging the application liquid supplied from the tank 100. The application liquid in the tank 100 is fed toward the nozzle 50 by a liquid feeding system (to be described later) provided between the tank 100 and the nozzle 50, and discharged from a discharge port provided on the tip of the nozzle 50.

The base material S to which the application liquid is to be applied is arranged at a position facing the nozzle 50 by a conveying unit 70. Specifically, the base material S in the form of a long sheet wound into a roll is set on a feed roller 71 of the conveying unit 70 and one end part of the base material S is wound on a take-up roller 72. By the rotation of the take-up roller 72 in a direction of an arrow Dr of FIG. 2, the base material S is dispensed from the feed roller 71, fed in a direction of an arrow Ds and taken up on the take-up roller 72. That is, the conveying unit 70 has a function of supporting the sheet S as the application object and a function of conveying the sheet S. The nozzle 50 is arranged to face a surface of the base material S mounted on the feed roller 71 and the take-up roller 72 in this way. Thus, the application liquid discharged from the nozzle 50 is applied on the surface of the base material S. By the feed of the base material S in the direction of the arrow Ds, the application liquid can be applied on the base material S while relatively scanning and moving the nozzle 50 with respect to the base material S. The operations of the respective part of thus constructed application apparatus 1 are controlled by a control unit not shown in the figure.

Here, an electrode for battery formed by laminating an active material layer on a surface of a current collector can be produced, for example, using a conductive sheet, which is made of metal or the like and functions as the current collector, as the base material S and paste containing an active material as the application liquid.

The liquid feeding system 10 in this application apparatus 1 includes an output pipe 11 having one end part connected to a bottom part of the tank 100, a pump 12 arranged at an intermediate position of the output pipe 11, a defoaming unit 13 connected to the other end part of the output pipe 11, a feed pipe 14 connecting the defoaming unit 13 and the nozzle 50 to feed the application liquid to the nozzle 50, and a reflux pipe 15 connecting the defoaming unit 13 and the tank 100 to reflux the application liquid into the tank 100.

The pump 12 is for causing the application liquid to flow in the liquid feeding system 10 and desirably capable of feeding the high-viscosity application liquid at a stable flow rate. A screw pump can be, for example, used as such a pump. For example, a Mohno pump which is one type of a uniaxial screw pump can be preferably applied. The operation of the pump 12 is controlled by a control unit. The pump 12 is actuated in response to a control signal from the control unit, whereby the application liquid flows at a predetermined flow rate in each pipe constituting the liquid feeding system 10.

If the high-viscosity liquid is thixotropic, it is necessary to constantly apply a shear force to the liquid to maintain the fluidity of the liquid. For this purpose, an agitating wing 101 which rotates about a vertical axis in response to a control signal from the control unit is provided in the tank 100. Further, it is possible to apply a shear force to the application liquid and maintain a highly viscous state having a high fluidity by refluxing the application liquid fed to the output pipe 11 from the tank 100 into the tank 100 via the defoaming unit 13 and the reflux pipe 15. Specifically, in this embodiment, the tank 100, the output pipe 11, the pump 12, the defoaming unit 13 and the reflux pipe 15 integrally constitute a circulation path for the application liquid.

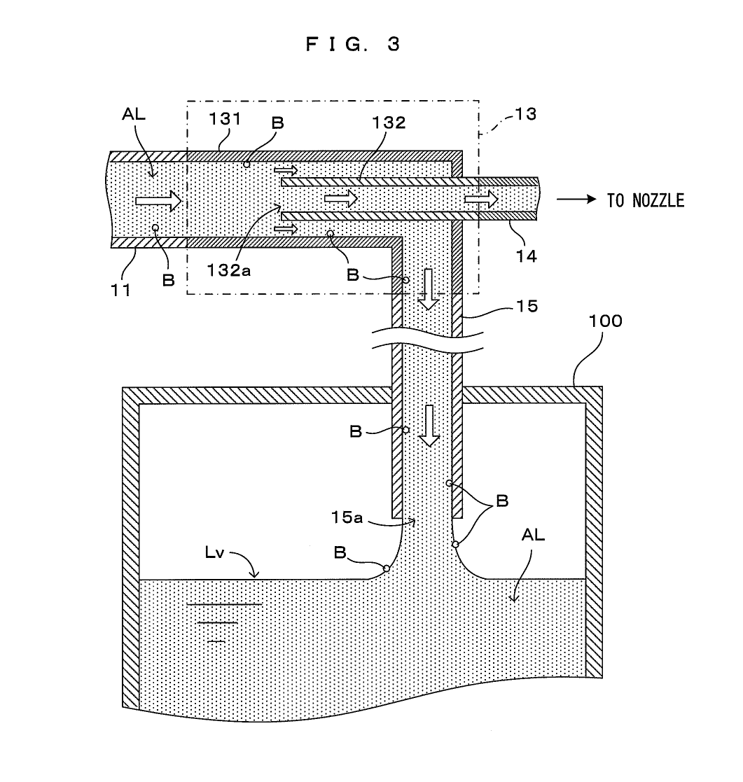

FIG. 3 is a side sectional view showing the internal structures of the defoaming unit and the reflux pipe. Note that the agitating wing 101 in the tank 100 is not shown in FIG. 3 to make FIG. 3 easily seeable. As shown in FIG. 3, the defoaming unit 13 has such a double pipe structure that an inner pipe 132 having one end connected to the feed pipe 14 is inserted in an outer pipe 131 having one end connected to the output pipe 11 and the other end connected to the reflux pipe 15. The outer pipe 131 is formed of a material having lower wettability with the application liquid AL than the other pipes connected thereto, i.e. the output pipe 11 and the reflux pipe 15.

In FIG. 3, outline arrows schematically show a direction of the flow of the application liquid AL in each part. This also holds true in each of the following figures. Although bubbles B may be included in the application liquid AL flowing into the defoaming unit 13 via the output pipe 11, they mainly flow along a pipe wall as described above. The bubbles B flowing along the pipe wall of the output pipe 11 and into the defoaming unit 13 are trapped on an inner wall surface of the outer pipe 131 having low wettability with the application liquid AL. Specifically, the inner wall surface of the outer pipe 131 functions as a bubble trap.

On the other hand, the inner pipe 132 connected to the feed pipe 14 is formed of a material having higher wettability with the application liquid AL than the outer pipe 131. Thus, the bubbles B are unlikely to adhere to the inner pipe 132. As just described, a flow passage from a central part of the liquid flow including less bubbles B to the feed pipe 14 is branched and the inner pipe 132 connected to the feed pipe 14 is formed of the material having high wettability with the application liquid AL. On the other hand, the outer pipe 131 connected to the output pipe 11 and surrounding the inner pipe 132 is formed of the material having lower wettability than the inner pipe 132. In this way, a probability that the bubbles B in the liquid flow into the feed pipe 14 via the inner pipe 132 is made very low.

By preventing the bubbles B in the liquid from flowing into the inner pipe 132 by being trapped on the inner wall surface of the outer pipe 131 as just described, the inclusion of bubbles in the application liquid fed to the nozzle 50 via the feed pipe 14 is prevented, thereby being able to prevent a variation of an application amount and application defects due to the bubbles. To make this effect more reliable, an upstream (left in FIG. 3) end part of the bubble trap (outer pipe 131 in this case) in the flowing direction of the application liquid is preferably located at least upstream of an opening 132a of the inner pipe 132. Further, a downstream (right in FIG. 3) end part of the bubble trap (outer pipe 131 in this case) extends up to a position downstream of the opening 132a of the inner pipe 132 so that the bubbles separated from the wall surface do not enter the inner pipe 132.

The bubbles B adhering to the pipe wall of the outer pipe 131 functioning as the bubble trap move along the pipe wall to a further downstream side by the flow of the application liquid AL from the outer pipe 131 toward the reflux pipe 15. Specifically, the bubbles B are guided into the tank 100 via the reflux pipe 15 together with the application liquid AL.

In the tank 100, the reflux pipe 15 is open downward at a position at the same height as or slightly above a liquid surface Lv of the application liquid AL stored in the tank 100. The application liquid AL flowing into the reflux pipe 15 via the outer pipe 131 of the defoaming unit 13 is discharged from an opening 15a of the reflux pipe 15. The application liquid AL flows down in the form of a liquid column and is mixed with the application liquid in the tank 100. In this way, the application liquid AL is circulated.

Since the bubbles B included in the application liquid AL discharged from the opening 15a of the reflux pipe 15 move along the pipe wall of the reflux pipe 15, they appear on the surface of the liquid column when being exposed to an atmosphere in the tank 100. By exposing the bubbles B to the surrounding atmosphere in this way, the bubbles B are dissipated. By the continuous circulation of the application liquid AL via a circulation path, the bubbles in the liquid can be gradually decreased.

As described above, in this embodiment, the bubbles included in the application liquid AL are prevented from being fed to the nozzle 50 by providing the defoaming unit 13 having the double pipe structure in the flow passage. More specifically, the defoaming unit 13 has such a double pipe structure that the inner pipe 132 is inserted in the outer pipe 131 connected to the output pipe 11 for feeding the application liquid AL to the defoaming unit 13. The inner pipe 132 is connected to the feed pipe 14 communicating with the nozzle 50. The inner pipe 132 is formed of the material having relatively high wettability with the application liquid, whereas the outer pipe 131 is formed of the material having lower wettability. In this way, the bubbles adhere to the outer pipe 131 in a concentrated manner and the entry of the bubbles into the feed pipe 14 via the inner pipe 132 is prevented. Thus, in this embodiment, the application liquid having the bubbles removed therefrom can be supplied to the nozzle 50.

### Second Embodiment

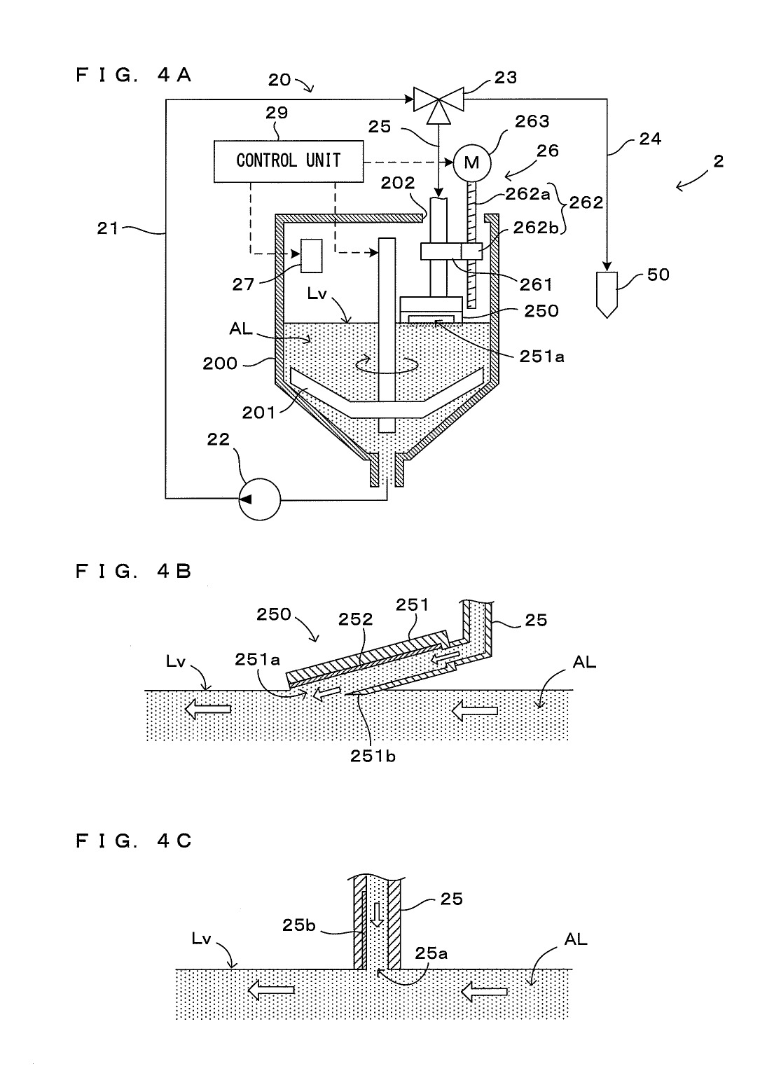

FIGS. 4A through 4C are diagrams showing a second embodiment of the application apparatus according to this invention. Note that an application apparatus 2 of this embodiment includes a conveying unit for holding and conveying a base material besides a configuration shown in FIG. 4A. The configuration and effects of this conveying unit are neither shown nor described since being the same as the conveying unit 70 provided in the first embodiment. As shown in FIG. 4A, this application apparatus 2 includes a tank 200 for storing an application liquid AL to be applied inside, a liquid feeding system 20 connecting this tank 200 and a nozzle 50 and a control unit 29 for controlling each component.

First, the liquid feeding system 20 is described. The liquid feeding system 20 in this application apparatus 2 includes an output pipe 21 having one end part connected to a bottom part of the tank 200, a pump 22 arranged at an intermediate position of the output pipe 21, a three-way valve 23 having an input port connected to the other end part of the output pipe 21, a feed pipe 24 connecting one output port of the three-way valve 23 and the nozzle 50 to feed the application liquid to the nozzle 50, and a reflux pipe 25 connected to another output port of the three-way valve 23 to reflux the application liquid into the tank 200.

The structures and functions of the output pipe 21 and the pump 22 are not respectively described since being the same as those of the output pipe 11 and the pump 12 provided in the first embodiment. The three-way valve 23 operates in response to a control signal from the control unit 29. In this way, a feeding path in which the output pipe 21 and the feed pipe 24 are connected and a circulation path in which the output pipe 21 and the reflux pipe 25 are connected are selectively opened. In the case of opening the feeding path in which the output pipe 21 and the feed pipe 24 are connected, the application liquid fed under pressure from the tank 200 is supplied to the nozzle 50 via the feed pipe 24. On the other hand, in the case of opening the circulation path in which the output pipe 21 and the reflux pipe 25 are connected, the application liquid fed under pressure from the tank 200 is refluxed to the tank 200 via the circulation path. A viscosity increase due to a thixotropic property is suppressed by causing the application liquid AL to constantly flow as just described.

An end part of the reflux pipe 25 opposite to an end part connected to the three-way valve 23 is laterally expanded in diameter to serve as a reflux nozzle 250. An opening 202 is provided on the upper surface of the tank 200. The reflux pipe 25 extends into the tank 200 from the outside of the tank 200 and a supporting mechanism 26 for supporting the reflux pipe 25 is inserted through the opening 202. The reflux pipe 25 is supported in the tank 200 by a supporting block 261 of the supporting mechanism 26. The supporting mechanism 26 further includes a ball screw mechanism 262 and a motor 263. A ball screw 262a of the ball screw mechanism 262 is coupled to a rotary shaft of the motor 263 and inserted into the opening 202 to extend substantially in a vertical direction. On the other hand, the supporting body 261 is fixed to a nut 262b engaged with the ball screw 262a. The motor 263 is fixed to a case of the tank 200 by an unillustrated fixing member.

A part of the reflux pipe 25 is constituted by a pipe having resistance against components of the application liquid and flexibility, e.g. a flexible tube made of stainless steel. When the motor 263 is actuated in response to a control signal from the control unit 29, the ball screw 262a rotates, the nut 262b vertically moves and the supporting body 261 moves upward or downward together with the nut 262b, whereby the reflux pipe 25 is vertically moved. In this way, the reflux nozzle 250 provided on the tip of the reflux pipe 25 moves upward or downward.

Further, a liquid level sensor 27 for detecting the position of the liquid surface of the application liquid stored in the tank 200 is provided in an upper part of the interior of the tank 200. Any arbitrary liquid level sensor such as one of those based on various measurement principles such as ultrasonic, floating, capacitance, electromagnetic and optical liquid level sensors can be used as the liquid level sensor 27 provided that it can detect the position of a liquid surface in the vertical direction. Further, the liquid surface may be optically imaged and the position thereof may be detected or the liquid surface position may also be detected by a combination with an index such as a gauge provided on a tank inner wall surface. A detection result by the liquid level sensor 27 is given to the control unit 29 and utilized in an operation control of each component by the control unit 29.

Further, an agitating wing 201, the rotation of which is controlled by the control unit 29, is further provided in the tank 200. By the rotation of the agitating wing 201 in an arrow direction, the application liquid AL stored in the tank 200 flows to be agitated. At this time, the liquid surface Lv of the application liquid AL rotates clockwise when viewed from above.

The reflux nozzle 250 provided on the tip of the reflux pipe 25 has a box-shaped nozzle case 251 long and narrow in a lateral direction (direction perpendicular to the plane of FIG. 4B) as shown in FIGS. 4A and 4B. A slit-like opening 251 a having a longitudinal direction parallel to the liquid surface Lv and communicating with the interior of the reflux pipe 25 is provided on a lower end of the nozzle case 251. The position of the nozzle case 251 in a height direction is so set that a nozzle bottom surface is in contact with the liquid surface Lv of the application liquid AL stored in the tank 200. The height of the liquid surface Lv is detected by the liquid level sensor 27 and the control unit 29 actuates the supporting mechanism 26 based on that detection result, whereby this positional relationship is maintained even if the height of the liquid surface Lv changes.

The nozzle case 251 is further arranged by being slightly inclined so that a flowing direction of the application liquid AL flowing into the reflux nozzle 250 from the reflux pipe 25 is along a moving direction of the liquid surface Lv. Specifically, the reflux nozzle 250 is so arranged that an upstream side in the flowing direction of the application liquid in this nozzle is an upstream side (right side in FIG. 4B) in the moving direction of the liquid surface Lv in the tank 200 and a downstream side in the flowing direction of the application liquid in the reflux nozzle 250 is a downstream side (left side in FIG. 4B) in the moving direction of the liquid surface Lv in the tank 200. Thus, the opening 251a of the nozzle case 251 is open toward the downstream side in the flowing direction of the liquid surface Lv.

According to such an arrangement, the application liquid AL flowing into the reflux nozzle 250 via the reflux pipe 25 is discharged from the opening 251a through the interior of the nozzle case 251 and joins the application liquid AL in the tank 200. At this time, since a direction of the application liquid AL discharged from the reflux nozzle 250 is substantially the same as the flowing direction of the liquid surface Lv in the tank 200, a turbulence of the liquid flow at a junction can be suppressed. Thus, the generation and the inclusion of bubbles into the liquid due to a turbulent flow is prevented. If a bottom surface 251b of the nozzle case 251 is formed into a tapered surface as shown in FIG. 4B, this effect is more notable.

Further, a bubble trap 252 formed of a material having lower wettability with the application liquid AL than the nozzle case 251 is provided on an inner wall of an upper part of the nozzle case 251, i.e. on a ceiling surface. The bubbles included in the application liquid AL flowing from the reflux pipe 25 are trapped by the bubble trap 251, move to a downstream side along the ceiling surface of the nozzle case 251 and are, thereafter, exposed to the liquid surface Lv in the tank 200 to be dissipated.

As just described, in the application apparatus 2 of this embodiment, the reflux nozzle 250 for returning the application liquid AL to the liquid surface Lv in the tank 200 in the circulation path for returning the application liquid AL discharged from the tank 200 to the tank 200 via the output pipe 21 and the reflux pipe 25 has a function as a defoaming unit for removing bubbles in a liquid. Specifically, the reflux nozzle 250 is so configured as to discharge the application liquid AL along the liquid surface Lv in the tank 200 and the opening 251 a is open toward the downstream side in the flowing direction of the liquid surface Lv, whereby the direction of the discharged application liquid is along the flowing direction of the liquid surface Lv. This prevents bubbles from being generated by entrapping the surrounding atmosphere when the application liquid AL is returned to the tank 200.

Further, the bubble trap 252 formed of the material having low wettability with the application liquid AL is provided on the inner wall of the upper part of the nozzle case 251. Thus, the bubbles in the liquid flowing into the reflux nozzle 250 from the reflux pipe 25 are exposed on the liquid surface Lv to be dissipated after being trapped by the bubble trap 252. Therefore, the bubbles included in the application liquid AL can be reduced by circulating the application liquid AL via the circulation path.

Note that the reflux nozzle 250 is not limited to the above structure and various structures are conceivable. Even if a lower end opening 25a of the reflux pipe 25 is merely brought into contact with the liquid surface Lv, for example, as shown in FIG. 4C, effects similar to the above can be obtained as follows. In this case, a partial wall surface 25b of the inner wall of the reflux pipe 25 located at a downstream side in the flowing direction of the liquid surface Lv may be formed of a material having lower wettability with the application liquid than other wall surfaces. According to such a configuration, the bubbles included in the application liquid AL flowing in the reflux pipe 25 are trapped on the wall surface 25b at the downstream side in the flowing direction of the liquid surface Lv before the opening 25a. Thus, when the application liquid AL in the pipe joins the application liquid AL in the tank 200, the bubbles are exposed on the liquid surface Lv without being entrapped in the liquid. In this way, the bubbles are dissipated.

### Third Embodiment

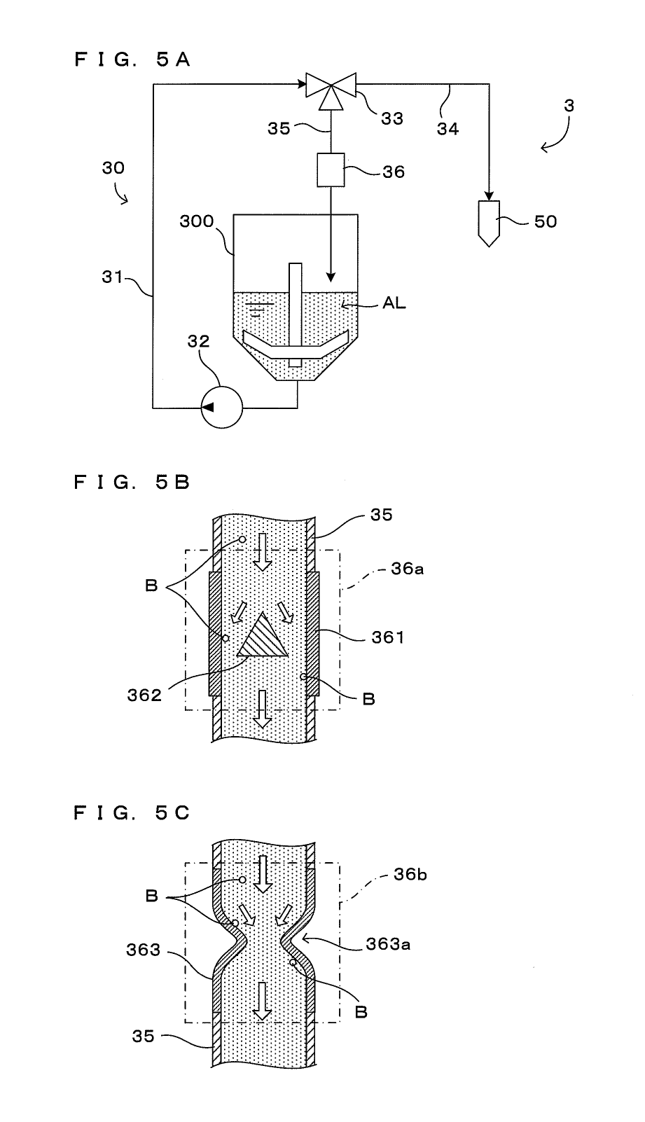

FIGS. 5A through 5C are diagrams showing a third embodiment of the application apparatus according to this invention. As shown in FIG. 5A, an application apparatus 3 of this embodiment is so structured that a liquid feeding system 30 is connected to a tank 300 for storing an application liquid AL. The tank 300 and the internal structure thereof are the same as the tank 100 and the internal structure thereof of the first embodiment and, hence, are not described in detail. Further, a conveying unit provided in this embodiment and having the same configuration as the conveying unit 70 of the first embodiment is also neither shown nor described. Besides, this application apparatus 3 includes a control unit for controlling the operation of each component.

In the liquid feeding system 30, an output pipe 31 is connected to a bottom part of the tank 300 and a pump 32 is provided on an intermediate position of the output pipe 31. The configurations and functions of these are similar to those of the corresponding output pipe 11 and pump 12 in the first embodiment. The output pipe 31 is connected to an input port of a three-way valve 33. Two output ports of the three-way valve 33 are respectively connected to a feed pipe 34 communicating with a nozzle 50 and a reflux pipe 35 communicating with the tank 300. By the operation of the three-way valve 33, a feeding path in which the output pipe 31 and the feed pipe 34 are connected and a circulation path in which the output pipe 31 and the reflux pipe 35 are connected are selectively opened as in the second embodiment.

A defoaming unit 36 of this embodiment is provided at an intermediate position of the reflux pipe 35. More specifically, the defoaming unit 36 composed of either a defoaming unit 36a configured as shown in FIG. 5B or a defoaming unit 36b configured as shown in FIG. 5C or formed by connecting these in series is disposed in the reflux pipe 35.

In the defoaming unit 36a shown in FIG. 5B, a tubular bubble trap 361 formed of a material having lower wettability with the application liquid AL than an inner wall of the reflux pipe 35 is inserted at an intermediate position of the reflux pipe 35. Further, a cone member 362 having a substantially conical shape is fixedly arranged near a tube axis in the bubble trap 361. The cone member 362 is formed of a material having wettability with the application liquid AL sufficiently higher than the bubble trap 361. In terms of mechanical strength, stainless steel can be, for example, used.

The application liquid AL fed through the reflux pipe 35 flows to a downstream side in such a manner as to slip through around the cone member 362. At this time, the flow of the liquid is changed in a direction from the pipe axis toward a pipe wall by the cone member 362, thereby increasing a probability that the bubbles B in the application liquid AL come into contact with the bubble trap 361.

As just described, a defoaming effect by the bubble trap 361 can be further improved not only by merely forming a part of the pipe wall of the material having low wettability, but also by controlling the direction of the flow so that the liquid flows toward this part having low wettability.

On the other hand, in the defoaming unit 36b shown in FIG. 5C, a tubular bubble trap 363 formed of a material having lower wettability with the application liquid AL than the inner wall of the reflux pipe 35 is provided. In the bubble trap 363, a part 363a in an axial direction is constricted to become a narrow part having a smaller pipe diameter than at other positions. Specifically, a flow passage cross-sectional area in the bubble trap 363 is partially smaller than other parts. Also by such a configuration, a probability that the bubbles B in the liquid approach a surface of the bubble trap 363 can be increased and a defoaming effect by the bubble trap 363 can be improved.

As described above, in the application apparatus 3 of this embodiment, the bubble trap 361, 363 formed of the material having lower wettability with the application liquid AL than the neighboring pipe is provided and the flow of the liquid is guided to the surface of the bubble trap 361, 363 so as to increase the probability that the bubbles approach this bubble trap 361, 363. Also by such a configuration, the bubbles included in the liquid can be effectively trapped.

### Fourth Embodiment

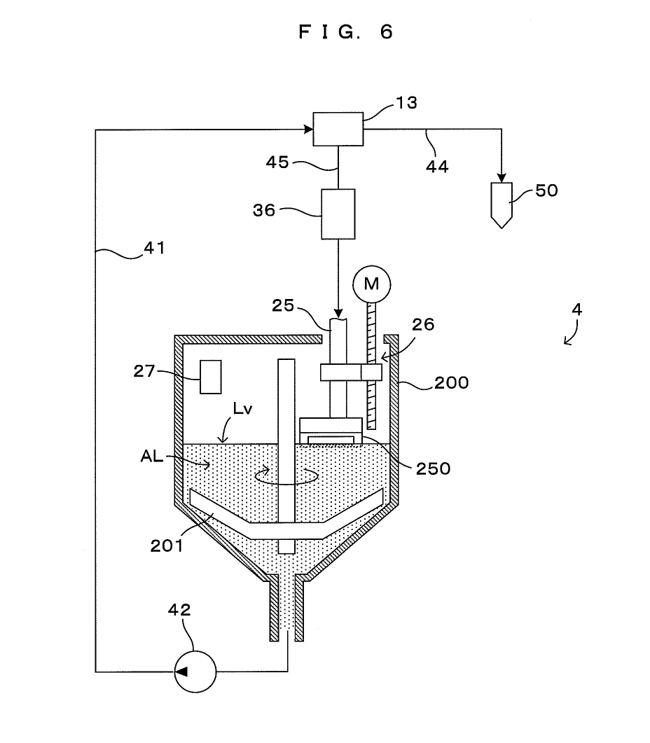

FIG. 6 is a diagram showing a fourth embodiment of the application apparatus according to this invention. An application apparatus 4 of the fourth embodiment is configured to include a combination of the defoaming units in the first to third embodiments described above. The defoaming unit of each of the above embodiments singly has a bubble removing function, but the effect thereof can be further enhanced by appropriately combining these as illustrated here. In this embodiment, components having the same configurations as in the above first to third embodiments are denoted by the same reference signs and not described. Further, a conveying unit provided in this embodiment and having the same configuration as the conveying unit 70 of the first embodiment is also neither shown nor described. Besides, this application apparatus 4 includes a control unit for controlling the operation of each component.

In the application apparatus 4 of this embodiment, a tank and the internal structure thereof are the same as the tank 200 and the internal structure thereof of the second embodiment. Specifically, a reflux nozzle 250 is provided on a lower end of a reflux pipe 25 inserted into a tank 200 and functions as a defoaming unit. The reflux pipe 25 including the reflux nozzle 250 is supported by a supporting mechanism 26.

An output pipe 41 is connected to a bottom part of the tank 200 and a pump 42 is provided on an intermediate position of the output pipe 41. The configurations and functions of these are similar to those of the corresponding output pipe 11 and pump 12 in the first embodiment. The defoaming unit 13 of the first embodiment is connected to the output pipe 41. The inner pipe 132 (FIG. 3) of the defoaming unit 13 is connected to a feed pipe 44 communicating with a nozzle 50, and an application liquid AL having bubbles removed therefrom as in the first embodiment is supplied to the nozzle 50.

The outer pipe 131 (FIG. 3) of the defoaming unit 13 is connected to a reflux pipe 45 and the defoaming unit 36 of the third embodiment is inserted at an intermediate position of the reflux pipe 45. This can promote the guiding of bubbles in the liquid to a pipe wall. The reflux pipe 45 is connected to the reflux pipe 25 to dissipate the bubbles when the application liquid AL is returned from the reflux nozzle 250 to the tank 200. As just described, in this embodiment, the bubbles in the liquid can be more reliably removed by combining the defoaming units of the above three embodiments.

### <Miscellaneous>

Next, the selection of the material of each component to effectively exhibit a defoaming action by each of the defoaming units described above is described. The liquid flowed using this type of the liquid feeding system contains various components and applied pipe materials differ depending on the components. Here, a case is considered where an active material layer of a lithium ion secondary battery is formed by applying. An organic solvent such as NMP (N-methyl-2-pyrrolidone), DMF (N,N-dimethyl formamide), DMAC (N,N-dimethyl acetamide), DMSO (dimethyl sulfoxide) or GBL (γ-butyrolactone) or water is mainly used as a solvent in preparing an application liquid used to apply an active material.

Degrees of wettability of a pipe material to these solvents can be indicated, for example, by critical surface tensions of this material. Specifically, a material having a smaller critical surface tension has lower wettability with a liquid and a material having a larger value has higher wettability.

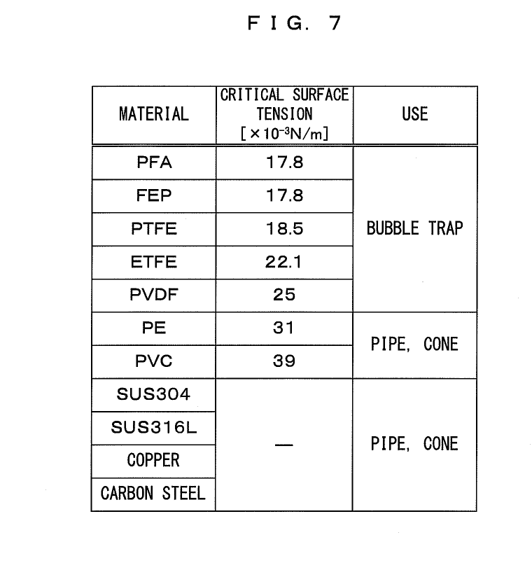

FIG. 7 is a table showing examples of the material usable as the pipe material. Typical examples of the pipe material usable for liquids (application liquids) containing the solvents described above include PFA (perfluoroalkoxy alkane), FEP (tetrafluoroethylene hexafluoropropylene copolymer), PTFE (polytetrafluoroethylene), ETFE (ethylene-tetrafluoroetheylene copolymer), PVDF (polyvinylidene fluoride), PE (polyethylene) and PVC (polyvinyl chloride). As shown in FIG. 7, fluororesin containing fluorine has a relatively small critical surface tension, whereas resin not containing fluorine has a larger value of the critical surface tension.

The inventor of this application conducted an experiment of causing an application liquid for an active material containing NMP as a solvent and including bubbles to flow in pipes formed of the above various materials and observing whether or not the bubbles adhered to pipe walls. As a result, the bubbles remained to adhere to the pipe wall when the fluororesins were used, whereas no adherence of bubbles was seen when PE and PVC were used.

From this, various fluororesins are preferable as bubble traps to which bubbles are caused to adhere, and a critical surface tension of the material is preferably 25×10⁻³ N/m or less. On the other hand, if the material has a critical surface tension of 30×10⁻³ N/m or more, a function as the bubble trap cannot be expected very much since the bubbles are unlikely to adhere. Such a material can be preferably used as a pipe material other than that for the bubble trap or a cone member. Besides, a metal material having a very large surface tension as compared with resin materials such as stainless steel (SUS 304, SUS316L, etc.), copper or carbon steel are considered as the pipe material other than that for the bubble trap.

As described above, in each of the above embodiments, the tank 100, 200, 300, 400 functions as a “storage” of the invention. Further, the nozzle 50 functions as an “application nozzle” of the invention.

Further, in the first embodiment, the feed pipe 14 functions as a “feed pipe” of the invention, whereas the reflux pipe 15 functions as a “reflux pipe” of the invention. Further, the defoaming unit 13 corresponds to a “branched part” of the invention. These and the output pipe 11 integrally function as a “flow pipe” of the invention.

Further, in the second embodiment, the feed pipe 24 functions as the “feed pipe” of the invention, whereas the reflux pipe 25 functions as the “reflux pipe” of the invention. Further, the agitating wing 201 functions as a “flow generator” of the invention, whereas the reflux nozzle 250 functions as a “reflux nozzle” of the invention. These and the output pipe 21 integrally function as the “flow pipe” of the invention.

Further, in the third embodiment, the feed pipe 34 functions as the “feed pipe” of the invention, whereas the reflux pipe 35 functions as the “reflux pipe” of the invention. Further, the cone member 362 and the narrow part 363a of the bubble trap 363 respectively fulfill a function as a “flow passage restrictor” of the invention by functioning as a “restricting member” of the invention and as a “narrow part” of the invention. These and the output pipe 31 integrally function as the “flow pipe” of the invention.

As described above, according to the invention, it is possible to effectively remove bubbles even from a non-Newtonian pasty high-viscosity liquid. Thus, in the application apparatus of the invention, a liquid having bubbles removed therefrom is supplied to the application nozzle and applied on an application object, whereby defect-free application can be performed at a stable application amount.

A more specific first mode of the invention, a flow pipe includes a branched part in which a feed pipe for feeding a liquid to an application nozzle and a reflux pipe for refluxing the liquid to a storage are branched, the branched part has such a double pipe structure that an inner pipe communicating with the feed pipe is inserted in an outer pipe communicating with the reflux pipe and an inner wall of the outer pipe is formed of a material having lower wettability with the liquid than a surface of the inner pipe and functions as a bubble trap.

As described above, bubbles in the liquid approach an inner wall of the flow pipe as the liquid flows in the flow pipe. Thus, if the branched part of the feed pipe toward the application nozzle and the reflux pipe for refluxing the liquid to the storage is configured to have the double pipe structure and cause the inner pipe thereof to communicate with the feed pipe while causing the outer pipe thereof to communicate with the reflux pipe, the bubbles in the liquid mainly flow along the inner wall of the outer pipe, thereby being able to effectively prevent the entry of the bubbles into the feed pipe toward the application nozzle via the inner pipe. Particularly, by forming the inner wall of the outer pipe of the material having low wettability with the liquid and causing it to function as the bubble trap, the flow of the bubbles into the feed pipe can be more reliably prevented.

In this case, for example, at least a part of the bubble trap may be provided at an upstream side of an opening of the inner pipe open in the outer pipe in a flowing direction of the liquid. According to such a configuration, the entry of the bubbles flowing together with the liquid into the feed pipe can be more effectively prevented since the bubbles are trapped at a side upstream of a junction to the feed pipe communicating with the application nozzle.

Further, for example, the reflux pipe may be so configured that the liquid flows into the storage from an opening open above a liquid surface of the liquid stored in the storage. According to such a configuration, the bubbles flowing along the pipe wall of the reflux pipe appear on the surface of the liquid flowing down to the storage from the opening and are dissipated by being exposed to a surrounding atmosphere. Thus, it is avoided that the bubbles are newly injected into the liquid being refluxed to the storage. Therefore, the total amount of the bubbles included in the liquid in the system can be reduced by repeating the reflux of the liquid.

Further, in a more specific second mode of the invention, a flow generator is provided to cause a liquid surface of a liquid stored in a storage to flow in a direction along the liquid surface, the flow pipe includes a feed pipe communicating with the application nozzle and a reflux pipe for refluxing the liquid to the storage, a downstream end part of the reflux pipe in the flowing direction of the liquid serves as a reflux nozzle for discharging the liquid and causing the liquid to flow into the storage, the reflux nozzle discharges the liquid to the liquid surface caused to flow by the flow generator and a bubble trap is provided in a flow passage for the liquid in the reflux nozzle.

According to such a configuration, the liquid surface of the liquid in the storage flows and the liquid refluxed from the reflux pipe via the reflux nozzle is discharged to the liquid surface flowing in this way. At this time, by providing the bubble trap in the flow passage, the bubbles in the liquid are guided to a pipe wall and injected into the storage from the reflux nozzle after flowing along the pipe wall. Since the bubbles moving along the inner wall of the reflux nozzle appear on the liquid surface when flowing into the storage, they are dissipated by being exposed to the surrounding atmosphere. Specifically, the bubbles in the liquid can be effectively removed also by such a mode.

In this case, the bubble trap may be, for example, provided on an inner wall surface of the reflux nozzle. According to such a configuration, the bubbles guided to the reflux nozzle can be effectively trapped to the inner wall surface of the reflux nozzle. Out of the inner wall surface of the flow passage in the reflux nozzle, a lower part in the flowing direction of the liquid surface is preferable for the bubble trap.

Further, for example, the reflux nozzle may include a slit-shaped opening having a longitudinal direction parallel to the liquid surface of the liquid stored in the storage and perpendicular to the flowing direction of the liquid surface and discharge the liquid from the opening open toward the downstream side in the flowing direction near the liquid surface. In such a configuration, the bubbles can be effectively guided to the inner wall surface of the reflux nozzle and caused to appear on the liquid surface since the liquid is discharged from the reflux nozzle having a wide cross-sectional shape along the liquid surface. Further, the generation of new bubbles can be prevented by discharging the liquid toward the downstream side in the flowing direction near the liquid surface.

Further, in a more specific third mode of the invention, a flow passage restrictor is provided at a position near a bubble trap to reduce a flow passage cross-sectional area of a flow pipe along a flowing direction of a liquid. According to such a configuration, a chance of bringing bubbles in the liquid close to a pipe wall increases and an action of trapping the bubbles by the bubble trap can be further promoted by reducing the flow passage cross-sectional area of the flow pipe.

In this case, for example, the flow passage restrictor may include a restricting member formed of a material having higher wettability with the liquid than the bubble trap and arranged in the flow pipe. According to such a configuration, the liquid is pushed in a direction toward a pipe wall by the restricting member and a chance of bringing the bubbles closer to the pipe wall increases. By being formed of the material having high wettability, the adherence of the bubbles to the restricting member is suppressed.

Further, for example, a narrow part having a partially reduced cross-sectional area of the flow pipe may be provided in a part of the flow pipe and function as the flow passage restrictor. According to such a configuration, a chance of bringing the bubbles in the liquid closer to the pipe wall is increased by reducing the cross-sectional area of the flow pipe itself. In this case, it is more preferable to provide the bubble trap in the narrow part or at a side downstream of the narrow part in the liquid flowing direction. By doing so, the bubbles guided to the pipe wall by the narrow part can be effectively trapped and the outflow to the downstream side can be suppressed.

Further, for example, the flow pipe may be branched into a feed pipe communicating with an application nozzle and a reflux pipe for refluxing the liquid to a storage and the restricting member and the bubble trap may be provided in the reflux pipe. According to such a configuration, the arrival of the removed bubbles to the application nozzle along the pipe wall is suppressed since the bubbles are removed not in the path for the liquid toward the application nozzle, but in the path for refluxing the liquid to the storage.

Further in the defoaming method according to the invention, for example, the bubbles adhering to the bubble trap may be moved to the downstream side in the flowing direction of the liquid along the inner wall of the flow pipe and exposed to an atmosphere together with the liquid to be dissipated by causing the liquid to flow in the flow pipe. According to such a configuration, the amount of the bubbles in the entire system in which the liquid is caused to flow can be reduced not only by merely leaving the bubbles to stand, but also by dissipating the trapped bubbles after moving them along the pipe wall.

In these inventions, for example, the liquid may contain an organic solvent or water as a solvent and the bubble trap may be formed of fluororesin. The fluororesin is a material having very low wettability with general organic solvents and water. Thus, the fluororesin is preferable as a material of the bubble trap. By forming other parts of the flow pipe of a material having higher wettability with the liquid than the fluororesin, the fluororesin can be caused to effectively function as the bubble trap.

Further, for example, the application object may be a current collector material and the liquid may contain an active material. In this case, a structure which functions as an electrode of a chemical battery can be efficiently formed by applying the active material on the current collector material using the application apparatus according to the invention. Since the application apparatus according to the invention can stably apply a high-viscosity liquid, the amount of a solvent added to the active material can be reduced and resource saving and a reduction in environmental burden can be realized.

Note that the invention is not limited to the embodiments described above and various changes other than the aforementioned ones can be made without departing from the gist of the invention. For example, in the above embodiments, the bubble trap formed of a material having lower wettability with the liquid than neighboring members is provided in the pipe. However, it is sufficient to form a part of the bubble trap to be held in contact with the liquid on the inner wall of the pipe of a material having low wettability and it is not essential to form the entire bubble trap of the same material. In view of this point, the function as the bubble trap can be exhibited even if a film of a material having lower wettability than the pipe material is, for example, partially coated on the inner wall surface of the pipe.

Further, for example, although the outer pipe 131 of the defoaming unit 13 is entirely formed of the material having low wettability in the above first embodiment, only a partial range of the outer pipe in a pipe axis direction may be formed of the material having low wettability and caused to function as the bubble trap.

Further, for example, although the flow of the liquid is restricted through a reduction of the flow passage cross-sectional area by providing the cone member in the flow passage or reducing the pipe diameter in the above third embodiment, a method for restricting the flow of the liquid is not limited to these and the shape of the restricting member and that of the narrow part are arbitrary.

Further, although the application apparatus of each of the above embodiments includes the circulation path for circulating the application liquid, the technical concept of the invention to trap bubbles by the material having low wettability does not necessarily assume the circulation path. For example, the bubble trap may be provided at an intermediate position of a liquid feeding system including no circulation path or may be provided at an intermediate position of the feed pipe leading to the nozzle.

Further, for example, although the application apparatus of each of the above embodiments is an apparatus for manufacturing an electrode for a lithium ion secondary battery by applying an active material on a surface of a base material S that functions as a current collector, the application object and the material to be applied are arbitrary without being limited to these.

Although the invention has been described with reference to specific embodiments, this description is not meant to be construed in a limiting sense. Various modifications of the disclosed embodiment, as well as other embodiments of the present invention, will become apparent to persons skilled in the art upon reference to the description of the invention. It is therefore contemplated that the appended claims will cover any such modifications or embodiments as fall within the true scope of the invention.

What is claimed is:

1. An application apparatus, comprising:
a storage which stores a non-Newtonian pasty liquid;
a flow pipe in which the liquid fed from the storage is caused to flow;
an application nozzle which is connected to the pipe and discharges the liquid to apply the liquid on an application object,
wherein a part of an inner wall of the flow pipe is formed of a material having lower wettability with the liquid than a neighboring inner wall material of the flow pipe and functions as a bubble trap for trapping bubbles included in the liquid.

2. The application apparatus according to claim 1, wherein:
the flow pipe includes a branched part in which a feed pipe for feeding the liquid to the application nozzle and a reflux pipe for refluxing the liquid to the storage are branched;
the branched part has a double pipe structure that an inner pipe communicating with the feed pipe is inserted in an outer pipe communicating with the reflux pipe; and
an inner wall of the outer pipe is formed of a material having lower wettability with the liquid than a surface of the inner pipe and functions as the bubble trap.

3. The application apparatus according to claim 2, wherein at least a part of the bubble trap is provided at an upstream side of an opening of the inner pipe, which is open in the outer pipe, in a flowing direction of the liquid.

4. The application apparatus according to claim 2, wherein the reflux pipe causes the liquid to flow into the storage from an opening which is open above a liquid surface of the liquid stored in the storage.

5. The application apparatus according to claim 1, comprising a flow generator which causes a liquid surface of the liquid stored in the storage to flow in a direction along the liquid surface, wherein:
the flow pipe includes a feed pipe communicating with the application nozzle and a reflux pipe for refluxing the liquid to the storage;
a downstream end part of the reflux pipe in a flowing direction of the liquid serves as a reflux nozzle for causing the liquid to flow into the storage by discharging the liquid; and
the reflux nozzle discharges the liquid to the liquid surface caused to flow by the flow generator and the bubble trap is provided in a flow passage for the liquid in the reflux nozzle.

6. The application apparatus according to claim 5, wherein the bubble trap is provided on an inner wall surface of the reflux nozzle.

7. The application apparatus according to claim 5, wherein the reflux nozzle includes a slit-shaped opening having a longitudinal direction parallel to the liquid surface of the liquid stored in the storage and perpendicular to the flowing direction of the liquid surface and discharges the liquid from the opening which is open toward a downstream side in the flowing direction near the liquid surface.

8. The application apparatus according to claim 1, wherein a flow passage restrictor for reducing a flow passage cross-sectional area of the flow pipe along a flowing direction of the liquid is provided at a position near the bubble trap.

9. The application apparatus according to claim 8, wherein the flow passage restrictor includes a restricting member formed of a material having higher wettability with the liquid than the bubble trap and arranged in the flow pipe.

10. The application apparatus according to claim 8, wherein a narrow part where a cross-sectional area of the flow pipe is partially reduced is provided in a part of the flow pipe and functions as the flow passage restrictor.

11. The application apparatus according to claim 8, wherein the flow pipe is branched into a feed pipe communicating with the application nozzle and a reflux pipe for refluxing the liquid to the storage and the flow passage restrictor and the bubble trap are provided in the reflux pipe.

12. The application apparatus according to claim 1, wherein the liquid contains an organic solvent or water as a solvent and the bubble trap is formed of fluororesin.

13. The application apparatus according to claim 1, wherein the application object is a current collector material and the liquid contains an active material.

14. A defoaming method for removing bubbles from a non-Newtonian pasty liquid, comprising:
causing the liquid to flow into a flow pipe; and
causing bubbles in the liquid to adhere to a bubble trap provided on a part of an inner wall of the flow pipe and formed of a material having lower wettability with the liquid than a neighboring inner wall material of the flow pipe, thereby removing the bubbles.

15. The defoaming method according to claim 14, wherein the bubbles adhering to the bubble trap are moved to a downstream side in a flowing direction of the liquid along the inner wall of the flow pipe and exposed to an atmosphere together with the liquid to be dissipated by causing the liquid to flow in the flow pipe.
